(19) United States
(12) Patent Application Publication
(10) Pub. No.: US 2015/0196004 A1
(43) Pub. Date: Jul. 16, 2015

(54) Pet Waste System

(71) Applicants: Zachary Norman, Venice, CA (US); Natalie Youn, Venice, CA (US)

(72) Inventors: Zachary Norman, Venice, CA (US); Natalie Youn, Venice, CA (US)

(21) Appl. No.: 14/446,242

(22) Filed: Jul. 29, 2014

Related U.S. Application Data
(60) Provisional application No. 61/927,473, filed on Jan. 15, 2014.

(51) Int. Cl. A01K 1/01; A01K 1/015

(52) U.S. Cl. CPC A01K 1/0107; A01K 1/0155; A01K 1/0154

(57) ABSTRACT

A pet waste system using litter to absorb pet waste. Netting is used to hold the litter in the receptacle, further preventing, among other things, the litter from being kicked up by a pet. The litter generally comprises an organic, non-living material. The litter and/or receptacle can be delivered on a scheduled, recurring basis to a user of the pet waste system.

### CROSS-REFERENCE TO RELATED APPLICATION

This application claims priority to U.S. Provisional Application No. 61/927,473, filed Jan. 15, 2014, entitled, “Pet Waste Receptacle,” which is hereby incorporated by reference in its entirety.

### BACKGROUND OF THE INVENTION

1. Field of the Invention

The present invention relates to a pet waste system for use by household pets, such as dogs, for example. Pet owners have the responsibility of allowing the pet to relieve itself periodically. Oftentimes, the pet owner cannot let or take the pet outdoors, because the owner is simply not available to do so. Smaller pets, often found in apartments or generally smaller living spaces, need to relieve themselves more frequently, increasing the need for a convenient solution for them to relieve themselves as necessary.

2. Description of the Related Art

U.S. Pat. No. 8,522,719, which is incorporated herein entirety by reference, relates to a portable, fully-disposable, pet toilet whose cavity is fitted with living grass, living sod, or a grass-seed medium. It has a fitted, removable cover or fold-back lid to enable the shipping and disposal of the unit in its entirely. This pet toilet, however, has a number of drawbacks, which are addressed by the invention disclosed herein.

One notable problem is that grass is living and, therefore, perishable and not shelf-stable. Further, living grass is difficult and expensive to ship and store, requiring delivery in a timely manner. Grass availability is also subject to weather, and few farms provide grass appropriate for this type of use. Grass is also subject to product variability in the makeup of the product. Fitness of the product is a concern. Some people are even allergic to grass. Litter according to the present invention is more shelf stable, and it can be shipped less frequently to further save on shipping costs.

Another drawback of grass is that dogs do not like walking on wet surfaces. Indeed, a wet surface can deter a dog from using it. Grass stays wet as it is unable to absorb moisture readily. The pet waste system in accordance with one aspect of the present invention is able to absorb moisture.

Furthermore, dogs tend to be attracted to organic materials, although the material does not necessary have to be living. The litter according to one aspect of the present invention carries organic smells and natural attractants that remain viable as a litter for dogs to use, but make it shelf stable, providing a longer lasting useable area. Accordingly, this invention solves many problems of previous systems by using organic, non-living materials, which dogs are attracted to, while increasing the shelf life and stability of the product being used by the dog.

Litter is known to be used for cats. The user places the litter in a receptacle and after the cat uses it for a period of time, the litter is disposed of. The litter is generally a loose, granular material that is capable of absorbing moisture and odors. Cat litter, however, is not ideal for dogs as they have been found to prefer organic materials and the amount of waste that dogs produce is often much greater than that of a cat.

Moreover, unlike cats, many dogs kick with their hind legs after relieving themselves. This behavior is understood as a means for the dog to mark his or her territory, as their paws have scent glands which secretions are released by their kicking. Dogs excrete pheromones when they go to the bathroom, which explains their kicking behavior immediately after doing so. As such, use of cat litter in accordance with prior art methods for dogs is not suitable as the litter would be kicked all over the place by the dog. The pet waste system in accordance with one aspect of the present invention addresses this problem, among others.

According to one aspect of the present invention, the pet waste system comprises litter for absorbing pet waste; a receptacle for holding said litter; and a netting for holding said litter in said receptacle. In other aspects of the present invention, the litter and/or receptacle is delivered on a scheduled basis; the litter includes an attractant; the litter comprises an organic, non-living material; the litter comprises an inorganic material; the litter comprises a combination of inorganic and organic, non-living material; the receptacle comprises a cover and a base; the cover comprises a perforated edge to provide an opening; the cover is connected to the base by a hinge; the netting comprises a plurality of holes having a size and the litter has a plurality of litter pieces, each litter piece having a size, wherein the size of said plurality of holes is smaller than the size of most of said plurality of litter pieces; the netting is attached to the cover and/or base.

### BRIEF DESCRIPTION OF THE DRAWINGS

FIG. 1 illustrates an exemplary pet waste system in its open state in accordance with one embodiment of the present invention;

FIG. 2 illustrates an exemplary pet waste system in its open state in accordance with one embodiment of the present invention;

FIG. 3 illustrates an exemplary pet waste system in its closed state in accordance with one embodiment of the present invention;

FIG. 4 illustrates an exemplary pet waste system with a perforated, tear-off section; and

FIG. 5 illustrates an exploded view of the pet waste system shown in FIG. 4.

### DETAILED DESCRIPTION OF THE DRAWINGS

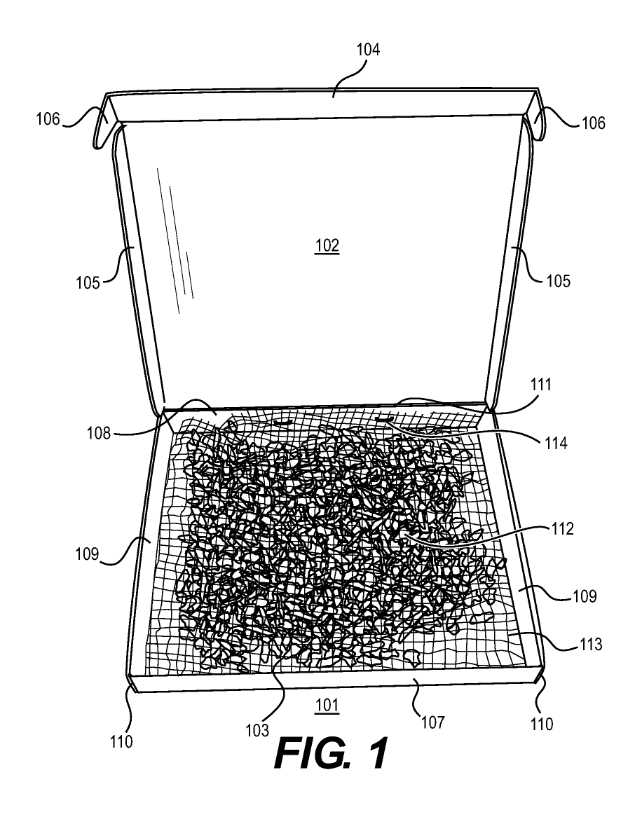

FIG. 1 illustrates pet waste system 101 in an open state in accordance with one embodiment of the present invention. Pet waste system 101 has a cover or lid 102 and base 103.

Cover or lid 102 has a front wall 104 and opposing sidewalls 105. Cover or lid 102 also has at least one tab 106 at an end of front wall 104. Base 103 has a front wall 107, a rear wall 108, and two opposing sidewalls 109. In between sidewall 109 and front wall 107 is at least one slot 110. Slot 110 is designed to receive tab 106. Cover or lid 102 is attached to base 103 along a seam 111. Seam 111 generally acts as a hinge. Seam 111 can also be perforated to allow for cover or lid 102 to be removed.

Base 103 holds litter 112. Litter 112 can be a variety of organic and inorganic materials, including, but not limited to, cellulose, plant fiber, wood chips, wood filings, bark, bark chips, wood shavings, moss, lichen, mulch, straw, potpourri, hay, dried grass, sawdust, wood pellets, sponge, sand, wildflower, any non-living grass or plant material such as peat, moss, fodder, for example. Various combinations of these materials are also possible. These are examples and any other substance that may absorb fluid and/or odor are well within the scope of the invention.

Netting 113 can be provided over litter 112 to hold litter 112 in place. Netting 113 can be made of a variety of materials, such as plastic, rope, yarn, thread, or any fiber capable of being woven in a grid-like structure. Netting 113 is held onto base 103 by use of at least one fastener 114 to tack it down. Fastener 114 can be, for example, a staple, tape, or adhesive.

Netting 113 has a plurality of holes. The size of the holes in the netting is generally smaller than the size of the pieces of litter so that the litter is held in place by the netting. There could, however, be pieces of litter that are smaller than the holes of the netting, which pieces are held in place by the larger pieces of litter. It is generally understood, however, that the netting and the plurality of holes therein are sized to hold much or most of the litter/litter pieces in place.

In one embodiment, litter can be held in a separate pouch, bag or container. “Pouch,” “bag” and “container” are used interchangeably herein and can be any vessel suitable for holding and/or containing litter. The pouch, bag or container can be suited to fit in the receptacle to be shipped along with the receptacle. The pouch or container can be used simply as a vessel from which the user pours the litter. Or the pouch or container can be either netted or have an opening so the container and litter together can be readily replaced by the user. For example, the bag can have a perforated edge, which can allow a user to remove a top section of the bag to expose the litter. A net pouch can also be used in conjunction with the bag to contain the litter. The bag can be plastic, or other suitable material that can be rolled up and packaged for easy shipping. The bag and/or pouch can be sold and used separately from the receptacle. A user can also use his or her own receptacle along with the bag and/or pouch, i.e., as a “refill.”

The pouch or container can be made of netting or any other suitable material, and can be closed in a number of ways, such as heat-sealing, sewing, zip ties, other ties. The pouch can also be held into the receptacle with fasteners as described for netting 113, above, but need not be.

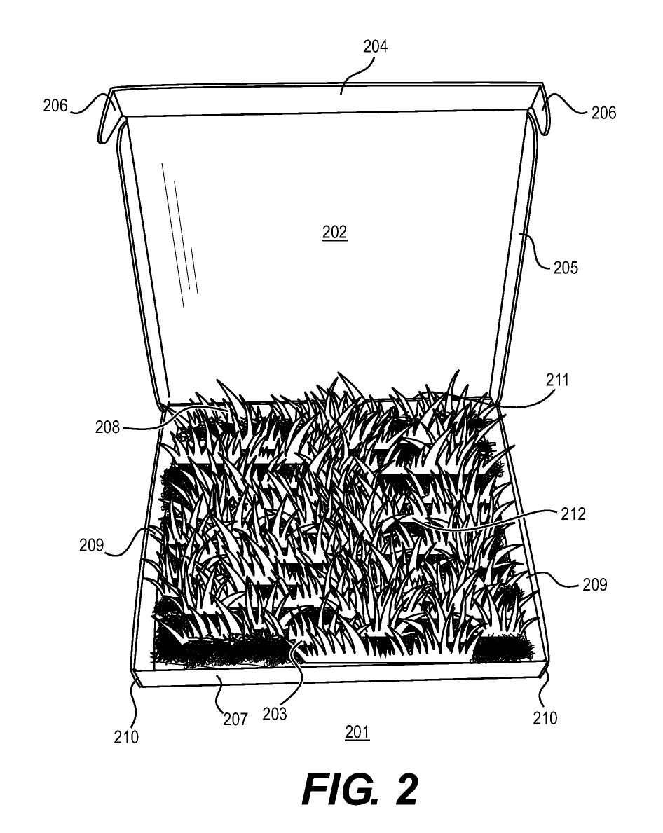

FIG. 2 illustrates pet waste system 201 in an open state in accordance with one embodiment of the present invention. Pet waste system 201 comprises cover or lid 202 and base 203.

Cover or lid 202 has a front wall 204 and opposing sidewalls 205. Cover or lid 202 also has at least one tab 206 at an end of front wall 204. Base 203 has a front wall 207, a rear wall 208, and two opposing sidewalls 209. In between sidewall 209 and front wall 207 is at least one slot 210. Slot 210 is designed to receive tab 206. Cover or lid 202 is attached to base 203 along a seam 211. Seam 211 generally acts as a hinge. Seam 211 can also be perforated to allow for cover or lid 202 to be removed.

Base 203 is shown with a grass or grass-like substance 212. An adhesive or fastener (not shown) may be used to removably or permanently affix the grass or grass-like substance to the base 203. Various types of grass, such as natural grass, matted grass, and/or woven grass are well within the scope of the invention.

A netting can also be used here to hold the grass or grass-like substance in place.

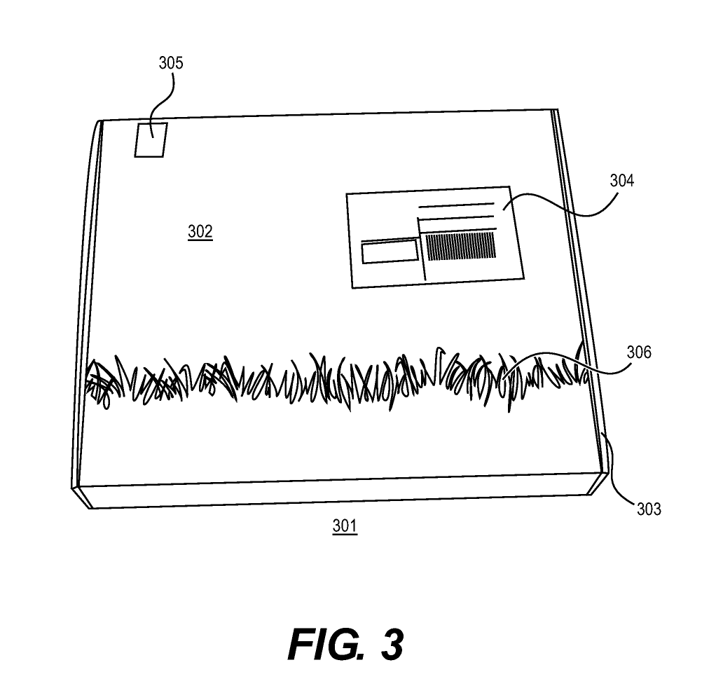

FIG. 3 illustrates pet waste system 301 in a closed state in accordance with one embodiment of the present invention. Receptacle 301 has a cover or lid 302 and a base 303. In a closed state, one or more tabs (not shown) are inserted into respective slots (not shown) to hold cover or lid 302 closed onto the base 303. On cover or lid 302 can also be a mailing slip 304 and postage 305 for the receptacle to be shipped without further packaging. Also on cover or lid 302 may be a decorative element 306 to reflect its contents and provide advertising.

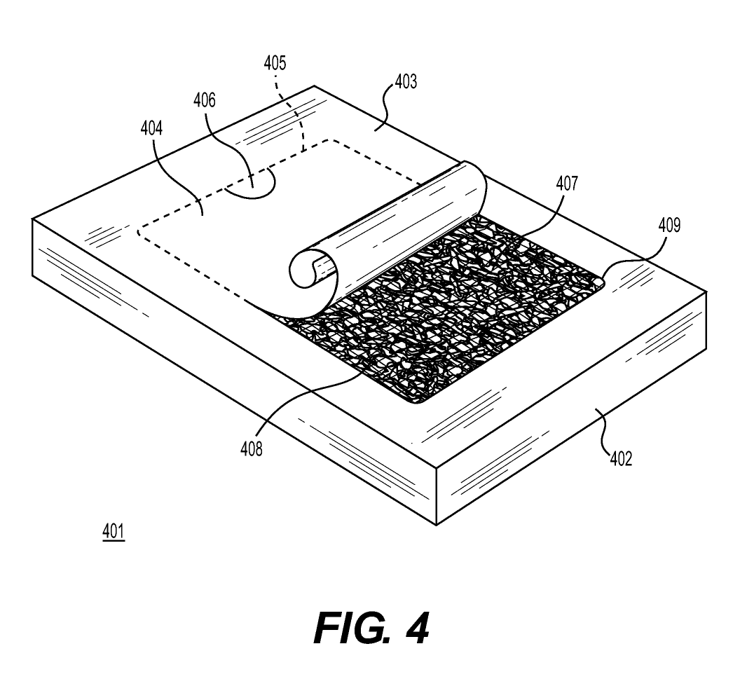

FIG. 4 illustrates an exemplary pet waste system 401 having a perforated, tear-off section 404. Pet waste system 401 has a bottom portion or tray 402 and upper portion or cover 403. Upper portion or cover 403 has a tear-off section 404 with a perforated edge 405 to provide an opening 409. Tear-off section 404 can optionally have at least one notch 406 at one or both ends of the tear-off section 404 to make the tear-off section 404 easier to remove for a user. Inside the pet waste system is litter 407, held in place by netting 408. The perforated, tear-off section keeps the litter in place during shipment and/or transport and can be easily removed (by peeling, for example) by a user to allow the pet to access and use the litter 407.

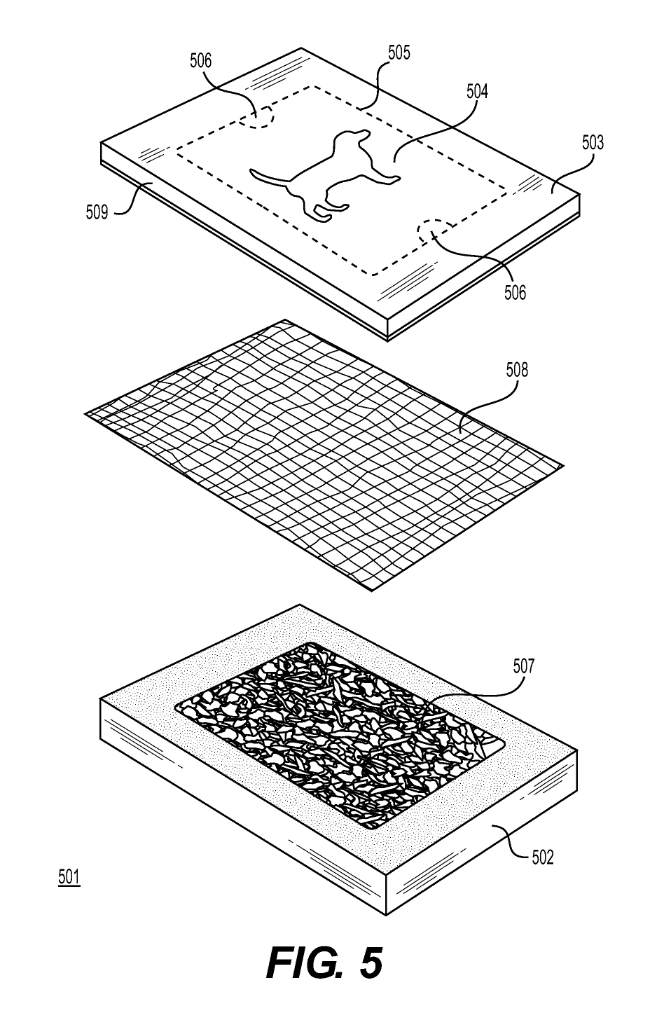

FIG. 5 illustrates an exploded view of exemplary pet waste system shown in FIG. 4. Pet waste system 501 has a bottom portion or tray 502 and upper portion or cover 503. Upper portion or cover 503 has a tear-off section 504 with a perforated edge 505. Upper portion or cover 503 can optionally have side walls 509. Tear-off section 504 can optionally have at least one notch 506 at one or both ends of the tear-off section 504 to make the tear-off section 504 easier to remove for a user. Inside the pet waste system is liter 507, held in place by netting 508. The perforated, tear-off section keeps the litter in place during shipment and/or transport and can be easily removed (by peeling, for example) by a user to allow the pet to access and use the litter 507. Netting 508 can be glued or otherwise attached to bottom portion or tray 502. Glue or other adhesive can be applied to the sides of bottom portion or tray 502 to attach to inside of side walls 509 of upper portion or cover 503.

As generally discussed above, netting 408 and 508 has a plurality of holes. The size of the holes in the netting is generally smaller than the size of the pieces of litter so that the litter is held in place by the netting. There could, however, be pieces of litter that are smaller than the holes of the netting, which pieces are held in place by the larger pieces of litter. It is generally understood, however, that the netting and the plurality of holes therein are sized to hold much or most of the litter/litter pieces in place.

Various types of materials can be used for the base and cover or lid of the pet waste system. For example, cardboard or any other biodegradable material can be used. Plastic materials can also be used. The receptacle can be a box or any other suitable container. The litter can also be used alone, i.e., without the box or container.

Instances in which a non water-resistant material is used for the base and/or cover or lid of the pet waste system, a water-resistant coating may be applied to portions of the pet waste system to prevent leakage through and breakdown of the receptacle. For example, wax has been found to work well as a coating to prevent liquid from permeating through the receptacle while being biodegradable itself. Other waterproofing materials, however, may be used and may be preferred over wax. A user may also supply his/her own base.

Holes (not shown in figures) can be placed in the cover or lid or base of the receptacle to provide ventilation. This may be desirable, for example, when the litter being used is a natural product requiring air flow. There can be any number of holes, but in one embodiment, 6-9 holes are provided and sized at 0.5 to 0.75 inches in diameter.

The receptacle and/or litter can be offered and/or mailed to and/or paid for by a user at regular and/or recurring intervals, for example, on a subscription basis. In the alternative, the litter can be delivered and/or paid for on a one-time basis. For example, the interval is variable, from days to years. This allows for a user to have fresh litter and/or receptacle at specified intervals, increasing convenience to the user.

The pet waste system of the present invention is not limited to particular examples provided above. For example, the litter can be organic or non-organic material. The litter can be shipped in the receptacle or alone to be used in a separate container. The delivery of the litter and/or receptacle can be recurring or can be delivered on a one-time basis. The receptacle may have holes or not, depending on the type of litter material. The receptacle may or may not have sides, as would be the case if shipped in a bag. Animals besides dogs and cats can use the receptacle. The receptacle can be waxed or otherwise waterproofed but need not be if the type of container is sufficient to do the job of containing the fluids without needing said waterproofing, for example, if the cardboard by virtue of its natural qualities works by itself The receptacle can be likewise water resistance or not. The receptacle can be provided with or without a lid. The receptacle can be provided with or without a cover. The receptacle can be provided with or without a base.

In one embodiment, the user can be sent litter in any kind of bag or container. The user can be sent litter in any kind of bag or container which is simply replaced in a recurring way; a cadence could be, but is not limited to, weekly bi-weekly or monthly. The container it is shipped in can be designed to make it easy for the customer to give his/her dog access to the litter by being relatively flat and by having a top or lid to expose the litter for the dog to go to the bathroom on. The container can, in one embodiment, have a net that holds the litter in place to prevent it from exiting the container or bag

Litter can be any material capable of absorbing urine or feces of an animal. The litter can be one of a variety of organic and inorganic materials, including, but not limited to, cellulose, plant fiber, wood chips, wood filings, bark, bark chips, wood shavings, moss, lichen, mulch, straw, potpourri, hay, dried grass, sawdust, wood pellets, sponge, sand, wildflower, any non-living grass or plant material such as peat, moss, fodder, for example. Various combinations of these materials are also possible.

An attractant can be used with the litter to encourage the dog to use the receptacle. The attractant can be synthetic or natural. The attractant can be a spray, and it can be disposed in or on the litter or receptacle prior to delivery and shipping. It can also be delivered separately to be applied by the user. A separate attractant can allow the user to “activate” the litter upon receipt, increasing shelf stability.

The container can be any object capable of holding the litter. It can be made of any material, synthetic or natural, for example, cardboard, plastic, wood, etc. It can also be made of a biodegradable material. The container can be disposable. The container is generally the vessel in which the litter is held and can be used to ship the litter

The receptacle can be any container capable of holding the litter. The receptacle can also be disposable.

The container and receptacle can be used together. For example, the container can be placed inside the receptacle so that the litter inside the container can be shipped inside the receptacle. The receptacle can be shipped with the litter alone without the litter being held in the container.

The litter, attractant, container and receptacle can be shipped/delivered all together, individually or in any combination. The delivery can occur as requested by the user or at specified intervals for automated delivery. Delivery can be recurring for one or all of the litter, attractant, container and receptacle. Automated delivery is also possible, along with automated payment for one or more or all of the litter, attractant, container and receptacle.

While the foregoing written description of the invention enables one of ordinary skill in the art to make and use the invention, those of ordinary skill in the art will understand and appreciate the existence of variations, combination, and equivalents of the embodiments, methods, and examples provided herein. The invention should, therefore, not be limited by the embodiments and examples disclosed here, but by all embodiments and methods within the scope and spirit of the invention as claimed.

We claim:

1. A pet waste system comprising:
litter for absorbing pet waste;
a receptacle for holding said litter; and
a netting for holding said litter in said receptacle.

2. A pet waste system according to claim 1, wherein said litter is delivered on a scheduled basis.

3. A pet waste system according to claim 1, wherein said receptacle is delivered on a scheduled basis.

4. A pet waste system according to claim 1, wherein said litter includes an attractant.

5. A pet waste system according to claim 1, where said litter comprises an organic, non-living material.

6. A pet waste system according to claim 1, where said litter comprises an inorganic material.

7. A pet waste system according to claim 1, where said litter comprises a combination of inorganic and organic, non-living material.

8. A pet waste system according to claim 1, wherein said receptacle comprises a cover and a base.

9. The pet waste system according to claim 8, wherein said cover comprises a perforated edge to provide an opening.

10. The pet waste system according to claim 8, wherein said cover is connected to said base by a hinge.

11. The pet waste system according to claim 1, wherein said netting comprises a plurality of holes having a size and said litter has a plurality of litter pieces, each litter piece having a size, wherein the size of said plurality of holes is smaller than said size of most of said plurality of litter pieces.

12. The pet waste system according to claim 11, wherein said netting is attached to said cover.

13. The pet waste system according to claim 11, wherein said netting is attached to said base.
